(19) United States
(12) Patent Application Publication
(10) Pub. No.: US 2020/0096043 A1
(43) Pub. Date: Mar. 26, 2020

(54) ROTARY MACHINE

(71) Applicant: MITSUBISHI HEAVY INDUSTRIES THERMAL SYSTEMS, LTD., Tokyo (JP)

(72) Inventors: Takeshi KANEKO, Tokyo (JP); Yuichi OTANI, Tokyo (JP); Jun MIYAMOTO, Tokyo (JP); Yasushi HASEGAWA, Tokyo (JP)

(73) Assignee: MITSUBISHI HEAVY INDUSTRIES THERMAL SYSTEMS, LTD., Tokyo (JP)

(21) Appl. No.: 16/472,102

(22) PCT Filed: Nov. 29, 2017
(86) PCT No.: PCT/JP2017/042768

§ 371 Date: Jun. 20, 2019

(30) Foreign Application Priority Data
Dec. 26, 2016 (JP) 2016-251470

(51) Int. Cl. F16C 33/66; F16C 37/00

(52) U.S. Cl. CPC F16C 33/6637; F16C 37/007

(57) ABSTRACT

A rotary machine of the present invention is provided with: a bearing including an inner ring secured to an outer peripheral surface of a rotating element, an outer ring disposed outside the inner ring, and a plurality of rolling elements interposed between the inner ring and the outer ring; a bearing housing disposed outside the bearing and to which the outer ring is secured; a casing disposed outside the bearing housing and to which the bearing housing is secured; and a temperature difference reducer to reduce a difference between a temperatures of the outer and inner rings.

### TECHNICAL FIELD

The present invention relates to a rotary machine.

The application is based upon and claims the benefit of priority from Japanese Patent Application No. 2016-251470, filed Dec. 26, 2016, the entire contents of which are incorporated herein by reference.

### BACKGROUND ART

A rotary machine includes a bearing configured to rotatably support a rotating element such as a rotation shaft. The bearing includes an inner ring that is disposed on a side of the rotating element, an outer ring that is disposed outside the inner ring, and a plurality of rolling elements that are interposed between the inner ring and the outer ring. The inner ring is secured to the rotating element. The outer ring is secured to a bearing housing. The bearing housing is accommodated in a casing.

According to the bearing with the aforementioned configuration, heat of the outer ring is easily dissipated through the bearing housing and the casing while it is difficult for heat of the inner ring to be dissipated.

Also, if a difference between a temperature of the inner ring and a temperature of the outer ring increases, there is a probability that a gap of the bearing in operation may decrease due to a difference in thermal expansion between the inner ring and the outer ring and the lifetime of the bearing may be shortened.

In a case in which the bearing is caused to rotate at a high speed, in particular, there is a probability that the lifetime of the bearing will be significantly shortened.

Patent Literature 1 discloses adjusting a length of a thinned part in an axial direction to be longer than a length of a crowning portion in the axial direction in order to suppress a temperature rise of the inner ring having inferior heat dissipation properties.

### CITATION LIST

### Patent Document

Patent Document 1: Japanese Patent No. 4196709

### SUMMARY OF INVENTION

### Technical Problem

However, according to the method disclosed in Patent Literature 1, it is difficult to perform such an adjustment, and the method is significantly complicated.

Thus, an object of the invention is to provide a rotary machine capable of easily preventing a lifetime of a bearing from being shortened.

### Solution to Problem

In order to achieve the aforementioned objects, a rotary machine according to an aspect of the invention includes: a rotating element; a bearing including an inner ring secured to an outer peripheral surface of the rotating element, an outer ring disposed outside the inner ring, and a plurality of rolling elements interposed between the inner ring and the outer ring; a bearing housing, which is disposed outside the bearing, to which the outer ring is secured; a casing, which is disposed outside the bearing housing, to which the bearing housing is secured; and a temperature difference reducer configured to reduce a difference between a temperature of the outer ring and a temperature of the inner ring.

According to the invention, it is possible to reduce a difference in thermal expansion between the inner ring and the outer ring by including the temperature difference reducer configured to reduce a difference between the temperature of the outer ring and the temperature of the inner ring. In this manner, it is possible to suppress a decrease in a gap of the bearing in operation and thereby to prevent a lifetime of the bearing from being shortened.

In addition, it is possible to prevent the lifetime of the bearing from being shortened as compared with a case in which a length of a thinned portion in an axial direction is adjusted to be greater than a length of a crowning portion in the axial direction (in a case in which the bearing itself is adjusted).

In addition, the temperature difference reducer may include a recessed portion that is formed on a portion of the casing which is brought into contact with an outer peripheral surface of the bearing housing in the rotary machine according to the aforementioned aspect of the invention.

Since a contact area between an inner peripheral surface of the casing and the outer peripheral surface of the bearing housing decreases by providing the recessed portion with such a configuration at the casing, it is possible to make it difficult for heat of the bearing housing in contact with the outer ring to be conveyed to the casing. In this manner, since a decrease in temperature of the outer ring is suppressed, and it becomes possible to reduce the difference in thermal expansion between the inner ring and the outer ring, it is possible to prevent the lifetime of the bearing from being shortened.

In addition, the temperature difference reducer may include a heat insulation material installed on an outer surface of the casing, and the bearing housing may have a lubricant oil-spraying portion configured to spray a lubricant oil on the bearing, in the rotary machine according to the aforementioned aspect of the invention.

In this manner, it becomes possible to suppress contact between the casing and external air and to keep heat of the rotary machine inside the heat insulation material by providing the heat insulation material at the outer surface of the casing. In this manner, since a decrease in temperature of the outer ring is suppressed, and it becomes possible to reduce the difference in thermal expansion between the inner ring and the outer ring, it is possible to prevent the lifetime of the bearing from being shortened.

In addition, it is possible to cool the entire bearing using the lubricant oil by including the lubricant oil-spraying portion configured to spray the lubricant oil on the bearing. In this manner, it is possible to suppress a significant rise of the temperature of the entire bearing.

In addition, the temperature difference reducer may include a low-heat conductivity member that is disposed between the bearing housing and the casing and has a lower heat conductivity than that of the casing in the rotary machine according to the aforementioned aspect of the invention.

In this manner, it is possible to suppress heat conduction between the bearing housing and the casing by disposing the low-heat conductivity member having a lower heat conductivity than that of the casing between the bearing housing and the casing. In this manner, since a decrease in temperature of the outer ring is suppressed, and it becomes possible to reduce the difference in thermal expansion between the inner ring and the outer ring, it is possible to prevent the lifetime of the bearing from being shortened.

In addition, the temperature difference reducer may include a heat-generating element installed between the bearing housing and the casing to heat the bearing housing, and the bearing housing may have a lubricant oil-spraying portion configured to spray a lubricant oil on the bearing in the rotary machine according to the aforementioned aspect of the invention.

In this manner, it is possible to heat the outer ring at which the temperature tends to be lowered as compared with the inner ring, by arranging the heat-generating element configured to heat the bearing housing between the bearing housing and the casing. In this manner, it becomes possible to reduce the difference in thermal expansion between the inner ring and the outer ring and to prevent the lifetime of the bearing from being shortened.

In addition, it becomes possible to cool the entire bearing using the lubricant oil by including the lubricant oil-spraying portion configured to s the lubricant oil on the bearing. In this manner, it is possible to suppress a significant rise in the temperature of the entire bearing.

In addition, at least one of the outer peripheral surface of the bearing housing and an inner peripheral surface of the casing which is brought into contact with the outer peripheral surface of the bearing housing may be a rough surface, and the temperature difference reducer may include the rough surface in the rotary machine according to the aforementioned aspect of the invention.

In this manner, since the contact area between the outer peripheral surface of the bearing housing and the inner peripheral surface of the casing is reduced by providing at least one of the outer peripheral surface of the bearing housing and the inner peripheral surface of the casing which is brought into contact with the outer peripheral surface of the bearing housing as a rough surface and by the temperature difference reducer including the rough surface, it becomes possible to make it difficult for the heat of the bearing housing in contact with the outer ring to be conveyed to the casing. In this manner, since a drop in temperature of the outer ring is suppressed, and it becomes possible to reduce the difference in the thermal expansion between the inner ring and the outer ring, it is possible to prevent the lifetime of the bearing from being shortened.

### Advantageous Effects of Invention

According to the present invention, it is possible to provide a rotary machine capable of preventing the lifetime of the bearing from being shortened.

### BRIEF DESCRIPTION OF DRAWINGS

FIG. 1 is a sectional view schematically illustrating an outline configuration of a compressor of a rotary machine according to a first embodiment of the invention.

FIG. 2 is a sectional view schematically illustrating an outline configuration of a compressor of a rotary machine according to a second embodiment of the invention.

FIG. 3 is a sectional view schematically illustrating an outline configuration of a compressor of a rotary machine according to a third embodiment of the invention.

FIG. 4 is a sectional view schematically illustrating an outline configuration of a compressor of a rotary machine according to a fourth embodiment of the invention.

FIG. 5 is a sectional view schematically illustrating an outline configuration of a compressor of a rotary machine according to a fifth embodiment of the invention.

FIG. 6 is an enlarged sectional view illustrating a portion surrounded by a region A illustrated in FIG. 5.

FIG. 7 is a an enlarged sectional view illustrating a portion surrounded by a region B illustrated in FIG. 5.

FIG. 8 is a graph illustrating relationships between absolute values of temperature differences between inner rings and outer rings and a plurality of bearings in a comparative example and an example.

FIG. 9 is a graph illustrating a temperature of an inner ring and a temperature of an outer ring in a comparative example.

FIG. 10 is a graph illustrating a temperature of an inner ring and a temperature of an outer ring in an example.

### DESCRIPTION OF EMBODIMENTS

Hereinafter, embodiments to which the invention is applied will be described in detail with reference to drawings.

### First Embodiment

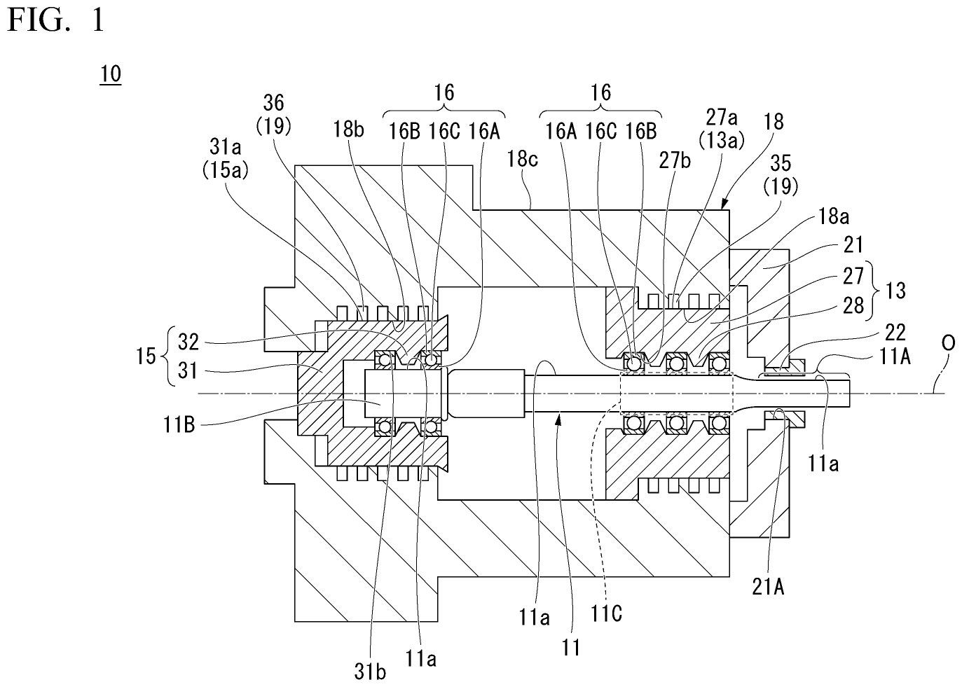

Referring to FIG. 1, a rotary machine 10 according to a first embodiment of the invention will be described. Note that O represented in FIG. 1 represents an axial line of a rotating element 11 (hereinafter, also referred to as an “axial line O”). FIG. 1 exemplifies a compressor as an example of the rotary machine 10. Also, FIG. 1 exemplifies a rotation shaft as an example of the rotating element 11.

The rotary machine 10 has the rotating element 11, bearing housings 13 and 15, a plurality of bearings 16, a casing 18, a temperature difference reducer 19, a support member 21, and a sealing member 22.

The rotating element 11 has a columnar shape and is disposed such that the rotation element 11 extends in a predetermined direction (an axial line O direction). The rotating element 11 has a tip end 11A, a base end 11B, and a bearing support portion 11C.

The tip end 11A is exposed from one end of the casing 18. The base end 11B is accommodated in the casing 18. The base end 11B is a portion that is rotatably supported by the plurality of bearings 16. The bearing support portion 11C is disposed between the tip end 11A and the base end 11B.

The rotating element 11 with the aforementioned configuration has an outer peripheral surface 11a.

The bearing housing 13 has a bearing housing main body 27 and a lubricant oil-spraying portion 28. The bearing housing main body 27 is a member with a cylindrical shape. The bearing housing main body 27 accommodates the bearing support portion 11C in a state in which a gap where the bearings 16 can be disposed is made to be interposed between itself and the outer peripheral surface 11a of the bearing support portion 11C.

The bearing housing main body 27 has an outer peripheral surface 27a and outer ring fixed surfaces 27b. The outer peripheral surface 27a is a surface that is brought into contact with the casing 18. The outer peripheral surface 27a is a surface corresponding to an outer peripheral surface 13a of the bearing housing 13.

The outer ring fixed surfaces 27b are ring-shaped surfaces to which the outer rings 16B of the bearings 16 are secured on their inner side. The plurality of outer ring fixed surfaces 27b are disposed at predetermined intervals in the axial line O direction.

The lubricant oil-spraying portion 28 is provided inside the bearing housing main body 27. The lubricant oil-spraying portion 28 projects in a direction from the inside of the bearing housing main body 27 toward the bearing support portion 11C. The lubricant oil-spraying portion 28 is disposed between the bearings 16. The lubricant oil-spraying portion 28 is connected to a lubricant oil supply portion (not illustrated). The lubricant oil-spraying portion 28 has a function of cooling the entire bearings 16 by spraying a lubricant oil to the bearings 16.

The bearing housing 15 has a bearing housing main body 31 and a lubricant oil-spraying portion 32. The bearing housing main body 31 is a cylindrical member with one end configured as a blocked end and the other end configured as an open end. The bearing housing main body 31 accommodates the base end 11B in a state in which a gap where the bearings 16 can be disposed is interposed between itself and the outer peripheral surface 11a of the base end 11B.

The bearing housing main body 31 has an outer peripheral surface 31a and outer ring fixed surfaces 31b. The outer peripheral surfaces 31a are surfaces that are brought into contact with the casing 18. The outer peripheral surfaces 31a are surfaces corresponding to the outer peripheral surface 15a of the bearing housing 15.

The outer ring fixed surfaces 31b are ring-shaped surfaces to which the outer rings 16B of the bearings 16 are secured on their inner side. A plurality of outer ring fixed surfaces 31b are disposed at predetermined intervals in the axial direction O direction.

The lubricant oil-spraying portion 32 is provided inside the bearing housing main body 31. The lubricant oil-spraying portion 32 projects in a direction from the inside of the bearing housing main body 31 toward the base end 11B. The lubricant oil-spraying portion 32 is disposed between the bearings 16. The lubricant oil-spraying portion 32 is connected to a lubricant oil supply portion (not illustrated). The lubricant oil-spraying portion 32 has a function of cooling the entire bearings 16 by spraying a lubricant oil on the bearings 16.

The aforementioned bearing housings 13 and 15 are disposed outside the plurality of bearings 16.

The plurality of bearings 16 are disposed between the bearing support portion 11C and the bearing housing main body 27 and between the base end 11B and the bearing housing main body 27.

Each bearing 16 has an inner ring 16A, an outer ring 16B, and a plurality of rolling elements 16C.

The inner ring 16A is a ring-shaped member. The inner ring 16A is secured to the outer ring fixed surface 27b or the outer peripheral surface 11a of the rotating element 11 facing the outer ring fixed surface 31b.

The outer ring 16B is a ring-shaped member. The outer ring 16B is secured to the outer ring fixed surfaces 27b and 31b. The outer ring 16B is disposed outside the inner ring 16A such that the outer ring 16B faces the inner ring 16A. The plurality of rolling elements 16C are interposed between the inner ring 16A and the outer ring 16B. It is possible to use balls or rollers, for example, as the rolling elements 16C.

The plurality of bearings 16 with the aforementioned configuration rotatably support the rotating elements 11.

The casing 18 is a tubular member. The casing 18 accommodates the rotating element 11 except for the tip end 11A, the bearing housings 13 and 15, and the plurality of bearings 16. The casing 18 has inner peripheral surfaces 18a and 18b and an outer surface 18c.

The inner peripheral surface 18a is a surface that is brought into contact with the outer peripheral surface 13a of the bearing housing 13. The inner peripheral surface 18b is a surface that is brought into contact with the outer peripheral surface 15a of the bearing housing 15. The outer surface 18c is a surface that is brought into contact with external air.

The temperature difference reducer 19 is configured to include a plurality of recessed portions 35 and 36. The plurality of recessed portions 35 are provided at portions of the inner peripheral surface 18a of the casing 18. The recessed portions 35 may be holes or slit-shaped or ring-shaped grooves, for example.

The plurality of recessed portions 36 are provided at portions of the inner peripheral surface 18b of the casing 18. The recessed portions 36 may be holes or slit-shaped or ring-shaped grooves, for example.

The support member 21 is provided at one end of the casing 18. The support member 21 has a through-hole 21A into which the tip end 11A is inserted. A part of the tip end 11A projects outside the support member 21.

The sealing member 22 is a ring-shaped sealing member and is provided at the through-hole 21A.

Since a contact area between the inner peripheral surfaces 18a and 18b of the casing 18 and the outer peripheral surfaces 13a and 15a of the bearing housings 13 and 15 decreases by using the plurality of recessed portions 36 provided inside the casing 18 as the temperature difference reducer 19, it is possible to make it difficult for the heat of the bearing housings 13 and 15 that are brought into contact with the outer ring 16B to be conveyed to the casing 18 according to the rotary machine 10 in the first embodiment. In this manner, since the temperature of the outer ring 16B is prevented from dropping, and it is possible to reduce the difference in thermal expansion between the inner ring 16A and the outer ring 16B, it is possible to prevent the lifetime of the bearings 16 from being shortened.

Also, it is possible to prevent the lifetime of the bearings 16 from being shortened as compared with a case in which a length of a thinned portion in an axial direction is adjusted to be greater than a length of a crowning portion in the axial direction (in a case in which the bearing itself is adjusted).

### Second Embodiment

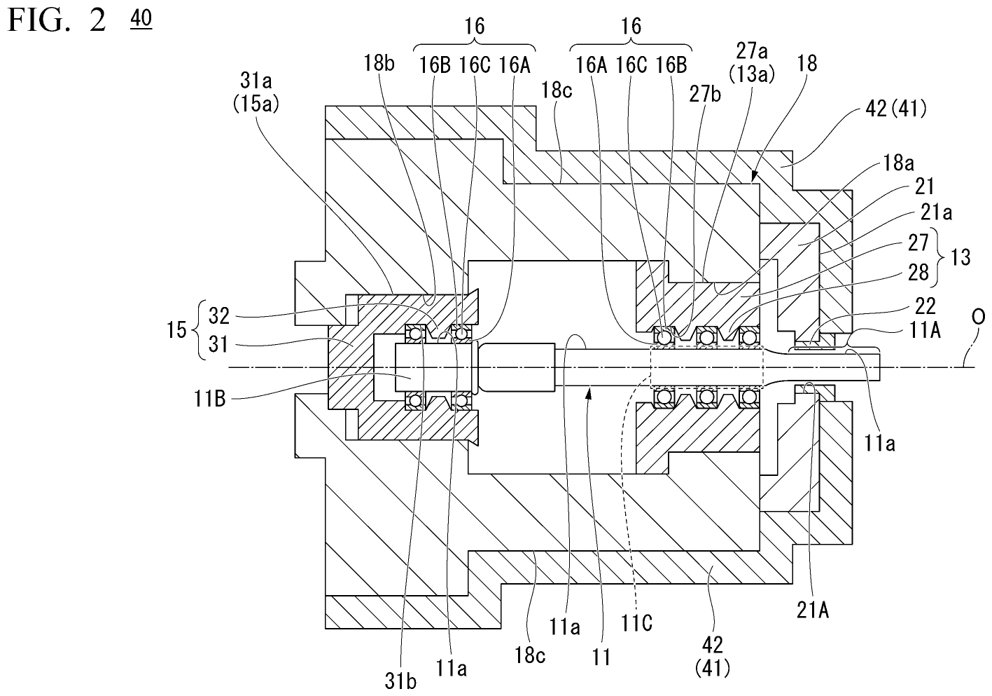

Referring to FIG. 2, a rotary machine 40 according to a second embodiment of the invention will be described. Note that in FIG. 2, the same reference numerals will be given to the same components as those in the structure body illustrated in FIG. 1.

The rotary machine is configured similarly to the rotary machine 10 according to the first embodiment other than the rotary machine 40 includes a temperature difference reducer 41 instead of the temperature difference reducer 19.

The temperature difference reducer 41 is configured to include a heat insulation material 42 covering an outer surface 18c of a casing 18 and an outer surface 21a of a support member 21.

As a heat insulation material 42, it is possible to use foam glass, glass wool, rock wool, calcium silicate, perlite, foam polystyrene, extruded foamed polystyrene, hard urethane foam, vinyl chloride foam, an insulation board, a sheathing board, an old newspaper heat insulation material, or the like.

According to the rotary machine 40 in the second embodiment, it becomes possible to suppress contact between the outer surface 18c of the casing 18 and external air and to keep heat of the rotary machine 40 inside the heat insulation material 42 by providing the heat insulation material 42 covering the outer surface 18c of the casing 18 and the outer surface 21a of the support member 21. In this manner, since the temperature of the outer ring 16B is prevented from dropping, and it is possible to reduce the difference in thermal expansion between the inner ring 16A and the outer ring 16B, it is possible to prevent the lifetime of the bearings 16 from being shortened.

In addition, it is possible to cool the entire bearings 16 using the lubricant oil and to thereby prevent the temperature of the entire bearings 16 from rising significantly by including the lubricant oil-spraying portion 28 sprays the lubricant oil on the bearings 16.

Note that the plurality of recessed portions 36 corresponding to the temperature difference reducer 19 described above in the first embodiment may be applied to the rotary machine 40 according to the second embodiment. In this manner, it is possible to further reduce the difference in thermal expansion between the inner ring 16A and the outer ring 16B and thereby to further prevent the lifetime of the bearings 16 from being shortened by combining the temperature difference reducer 19 according to the first embodiment and the temperature difference reducer 41 according to the second embodiment.

### Third Embodiment

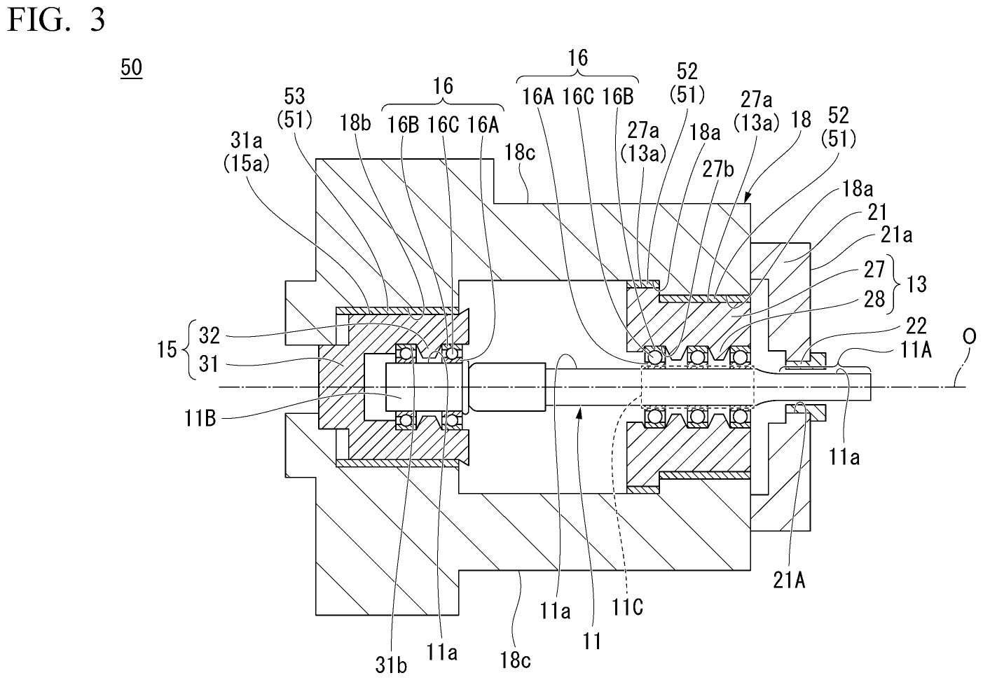

Referring to FIG. 3, a rotary machine 50 according to a third embodiment of the invention will be described. Note that in FIG. 3, the same reference numerals will be given to the same components of the structure body illustrated in FIG. 2.

The rotary machine 50 is configured similarly to the rotary machine 40 according to the second embodiment other than the rotary machine 50 has a temperature difference reducer 51 instead of the temperature difference reducer 41.

The temperature difference reducer 51 is configured to include low-heat conductivity members 52 and 53 with lower heat conductivity than that of a casing 18.

The low-heat conductivity member 52 is disposed between an outer peripheral surface 13a of a bearing housing 13 and an inner peripheral surface 18a of the casing 18. The low-heat conductivity member 53 is disposed between an outer peripheral surface 15a of a bearing housing 15 and an inner peripheral surface 18b of the casing 18.

As a material of the casing 18, it is possible to use a cast iron material, for example. In a case in which FC 300 (with heat conductivity of 43 W/(m·K)) that is a cast iron material, for example, is used as the material of the casing 18, low-heat conductivity members 52 and 53 with heat conductivity of less than 43 W/(m·K) are used. In this case, a stainless material, rubber, a resin material, or the like with heat conductivity of less than 43 W/(w·K), for example, may be used as the low-heat conductivity members 52 and 53.

As a specific stainless material, it is possible to use martensitic stainless steel, austenitic stainless steel, or ferritic stainless steel, for example.

As a specific cast iron material, it is possible to use gray cast iron, spherical graphite cast iron, or white cast iron, for example.

As specific rubber and a resin material, it is possible to use natural rubber, ethylene-propylene rubber, chloroprene rubber, silicon rubber, butyl rubber, polyurethane rubber, acrylic resin, epoxy resin, vinyl chloride resin, silicon resin, fluorine resin, phenol resin, bakelite, polyethylene resin, polycarbonate resin, polystyrene resin, or polypropylene resin, for example.

According to the rotary machine 50 in the third embodiment, it is possible to prevent the heat from being conveyed between the bearing housings 13 and 15 and the casing 18 by disposing the low-heat conductivity members 52 and 53 with lower heat conductivity than that of the casing 18 between the bearing housings 13 and 15 and the casing 18. In this manner, since the temperature of the outer ring 16B is prevented from dropping, and it is possible to reduce the difference in thermal expansion between the inner ring 16A and the outer ring 16B, it is possible to prevent the lifetime of the bearings 16 from being shortened.

Note that at least one temperature difference reducer in the temperature difference reducer 19 described above in the first embodiment and the temperature difference reducer 41 described above in the second embodiment may be combined with the rotary machine 50 according to the third embodiment.

In this manner, it is possible to further reduce the difference in the thermal expansion between the inner ring 16A and the outer ring 16B by combining at least one temperature difference reducer in the temperature difference reducer 19 described above in the first embodiment and the temperature difference reducer 41 described above in the second embodiment with the rotary machine 50 according to the third embodiment and thereby to further prevent the lifetime of the bearings 16 from being shortened.

### Fourth Embodiment

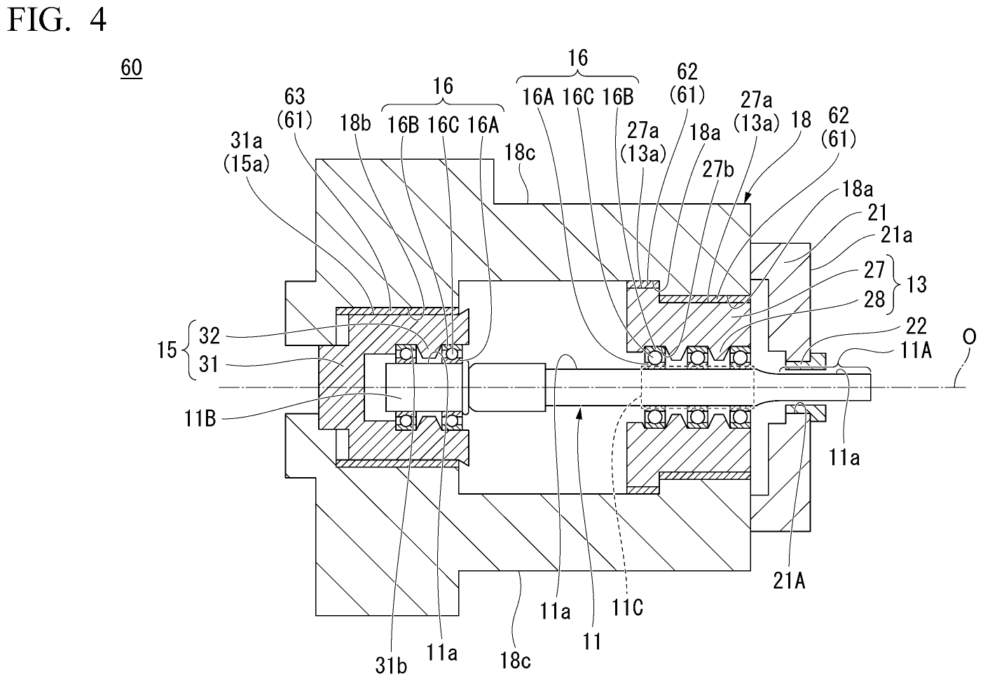

Referring to FIG. 4, a rotary machine 60 according to a fourth embodiment of the invention will be described. Note that in FIG. 4, the same reference numerals will be given to the same components as those in the structure body illustrated in FIG. 3.

The rotary machine 60 is configured similarly to the rotary machine 50 according to the third embodiment other than that the rotary machine 60 includes a temperature difference reducer 61 instead of the temperature difference reducer 51.

The temperature difference reducer 61 is configured to include heat-generating elements 62 and 63. The heat-generating element 62 is disposed between an outer peripheral surface 13a of a bearing housing 13 and an inner peripheral surface 18a of a casing 18. The heat-generating element 62 generates heat and heats the bearing housing 13.

The heat-generating element 63 is disposed between an outer peripheral surface 15a of a bearing housing 15 and an inner peripheral surface 18b of a casing 18. The heat-generating element 63 generates heat and heats the bearing housing 15.

As the heat-generating elements 62 and 63, it is possible to use heaters (for example, sheet-shaped heaters), for example.

According to the rotary machine 60 in the fourth embodiment, it is possible to heat the outer ring 16B, the temperature of which tends to drop as compared with the inner ring 16A, by disposing the heat-generating elements 62 and 63 for heating the bearing housings 13 and 15 between the bearing housings 13 and 15 and the casing 18. In this manner, it is possible to reduce the difference in thermal expansion between the inner ring 16A and the outer ring 16B and thereby to prevent the lifetime of the bearings 16 from being shortened.

Also, it is possible to cool the entire bearings 16 using the lubricant oil by including the lubricant oil-spraying portions 28 and 32 t configured to spray the lubricant oil on the bearings 16. In this manner, it is possible to prevent the temperature of the entire bearings 16 from significantly rising.

Note that at least one temperature difference reducer among the temperature difference reducers 19, 41, and 51 described above in the first to third embodiments may be combined with the rotary machine 60 according to the fourth embodiment.

In this manner, it is possible to further reduce the difference in thermal expansion between the inner ring 16A and the outer ring 16B by combining at least one of the temperature difference reducers 19, 41, and 51 described above in the first to third embodiments with the rotary machine 60 according to the fourth embodiment and thereby further prevent the lifetime of the bearing 16 from being shortened.

In addition, the low-heat conductivity members 52 and 53 may be disposed outside the heat-generating elements 62 and 63 in a case in which the low-heat conductivity members 52 and 53 described in the third embodiment are applied to the rotary machine 60 in the fourth embodiment.

### Fifth Embodiment

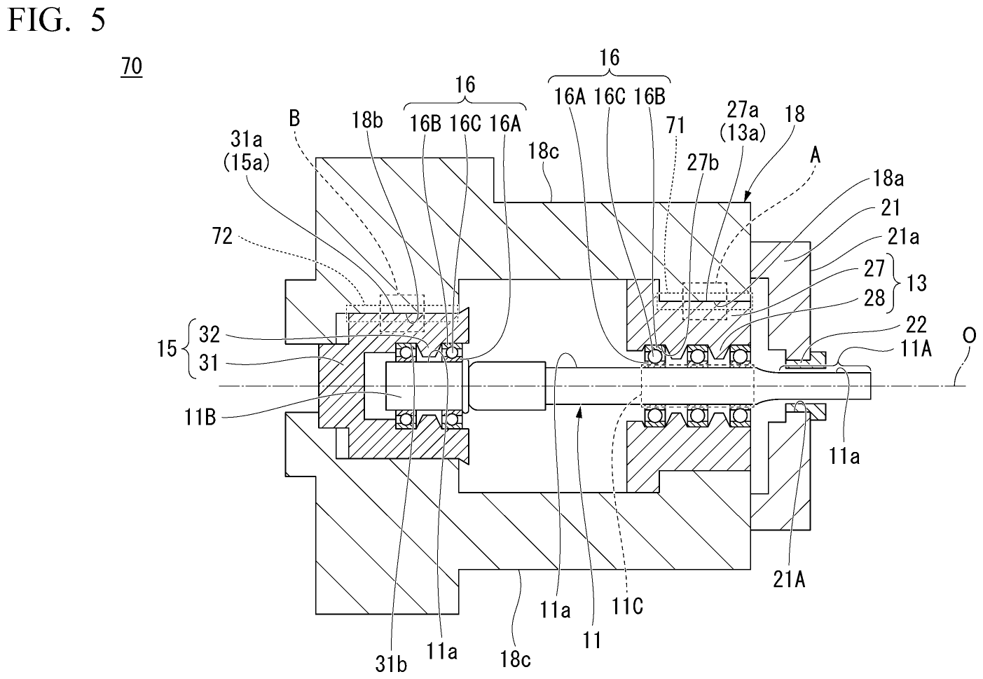

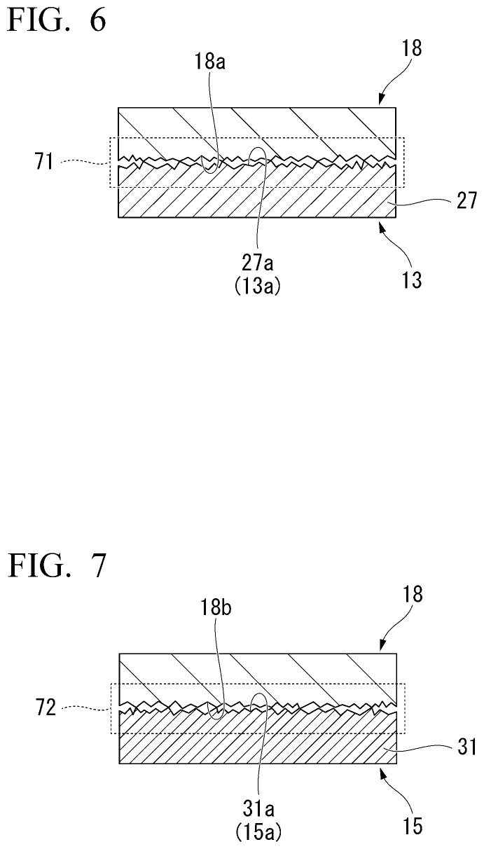

Referring to FIGS. 5 to 7, a rotary machine 70 according to a fifth embodiment of the invention will be described. Note that in FIG. 5, the same reference numerals will be given to the same components as those in the structure body illustrated in FIG. 2. Also, in FIGS. 6 and 7, the same reference numerals will be given to the same components as those in the structure body in FIG. 5.

The rotary machine 70 is configured similarly to the rotary machine 40 according to the second embodiment other than that the rotary machine 70 includes temperature difference reducers 71 and 72 instead of the temperature difference reducer 41.

The temperature difference reducer 71 is configured to include an inner peripheral surface 18a of a casing 18 that is formed as a rough surface (roughened surface) and an outer peripheral surface 13a of a bearing housing 13 that is formed as a rough surface. With such a configuration, a gap is formed between the inner peripheral surface 18a and the outer peripheral surface 13a, and it thus becomes possible to reduce the contact area between the inner peripheral surface 18a and the outer peripheral surface 13a.

The surface roughness of the inner peripheral surface 18a and the surface roughness of the outer peripheral surface 13a may be the same or different from each other.

The temperature difference reducer 72 is configured to include an inner peripheral surface 18b of the casing 18 that is formed as a rough surface (roughened surface) and an outer peripheral surface 15a of the bearing housing 15 that is formed as a rough surface. With such a configuration, a gap is formed between the inner peripheral surface 18b and the outer peripheral surface 15a, and it thus becomes possible to reduce the contact area between the inner peripheral surface 18b and the outer peripheral surface 15a.

The surface roughness of the inner peripheral surface 18a and the surface roughness of the outer peripheral surface 15a may be the same or different from each other.

Also, as a method of roughening the inner peripheral surfaces 18a and 18b and the outer peripheral surfaces 13a and 15a, it is possible to use a blast method (for example, a sand blast method), for example.

According to the rotary machine 70 in the fifth embodiment, the contact area between the outer peripheral surfaces 13a and 15a of the bearing housings 13 and 15 and the inner peripheral surfaces 18a and 18b of the casing 18 is reduced by forming the outer peripheral surfaces 13a and 15a of the bearing housings 13 and 15 and the inner peripheral surfaces 18a and 18b of the casing 18 that are brought into contact with the outer peripheral surfaces 13a and 15a of the bearing housings 13 and 15 as rough surfaces, and it thus becomes possible to make it difficult for heat of the bearing housings 13 and 15 that are brought into contact with the outer ring 16B to be conveyed to the casing 18. In this manner, since the temperature of the outer ring 16B is prevented from dropping, and it becomes possible to reduce the difference in thermal expansion between the inner ring 16A and the outer ring 16B, it is possible to prevent the lifetime of the bearings 16 from being shortened.

Note that although the case in which both the outer peripheral surfaces 13a and 15a of the bearing housings 13 and 15 and the inner peripheral surfaces 18a and 18b of the casing 18 are the rough surfaces has been exemplified and described in the fifth embodiment, it is only necessary for at least either the outer peripheral surfaces 13a and 15a of the bearing housings 13 and 15 or the inner peripheral surfaces 18a and 18b of the casing 18 to be rough surfaces. In this case, it is possible to achieve effects that are similar to those of the rotary machine 70 according to the fifth embodiment.

In addition, at least one temperature difference reducer among the temperature difference reducers 19, 41, 51, and 61 described above in the first to fourth embodiments may be combined with the rotary machine 70 according to the fifth embodiment.

In this manner, since it is possible to further reduce the difference in thermal expansion between the inner ring 16A and the outer ring 16B by combining at least one of the temperature difference reducers 19, 41, 51, and 61 described above in the first to fourth embodiments with the rotary machine 70 according to the fifth embodiment, it is possible to further prevent the lifetime of the bearings 16 from being shortened.

Although the preferred embodiments of the invention have been described above in detail, the invention is not limited to such specific embodiments, and various modifications and changes can be made within the gist of the invention described in the claims.

For example, a rotary machine in which the outer peripheral surfaces 13a and 15a of the bearing housings 13 and 15 and the inner peripheral surfaces 18a and 18b of the casing 18 that are included in the rotary machine 70 illustrated in FIG. 5 have not been subjected to roughening processing may be prepared, and fastening between the bearing housings 13 and 15 and the casing 18 may be slightly loosened.

With such a configuration, it is possible to reduce a pressure (hereinafter, referred to as a “contact pressure”) at which the outer peripheral surfaces 13a and 15a of the bearing housings 13 and 15 are brought into contact with the inner peripheral surfaces 18a and 18b of the casing 18.

In this manner, since a slight gap is formed between the outer peripheral surfaces 13a and 15a of the bearing housings 13 and 15 and the inner peripheral surfaces 18a and 18b of the casing 18, it is possible to make it difficult for heat of the bearing housings 13 and 15 to be conveyed to the casing 18. Therefore, the rotary machine configured in this manner can achieve effects that are similar to those of the rotary machine 70 according to the fifth embodiment described above.

The structure for reducing the contact pressure between the outer peripheral surfaces 13a and 15a of the bearing housings 13 and 15 and the inner peripheral surfaces 18a and 18b of the casing 18 may be applied to the rotary machines 10, 40, 50, 60, and 70 described above in the first to fifth embodiments.

Also, at least either the present bearing housings 13 and 15 or the casing 18, for example, may be formed of a material with lower heat conductivity than the heat conductivity of the current material (the bearing housings 13 and 15, the casing 18, or the bearing housings 13 and 15 and the casing 18).

Specifically, in a case in which the present material of the bearing housings 13 and 15 and the casing 18 is SS 400 (50) W/(m·K), it is possible to use an SUS material with heat conductivity of 16 W/(m·K), for example, as the material of the bearing housings 13 and 15 and the casing 18.

Since it becomes difficult for the temperature of the outer ring 16B to drop in the rotary machine configured in this manner, it is possible to achieve effects that are similar to those of the rotary machine 50 according to the third embodiment.

Also, such a change in material may be applied to the rotary machines 10, 40, 50, 60, and 70 according to the first to fifth embodiments described above.

Also, at least either the thickness of the bearing housings 13 and 15 or the thickness of the casing 18 may be configured to be thicker than the present thickness, for example.

In this manner, at least either the thickness of the bearing housings 13 and 15 or the thickness of the casing 18 may be configured to be thicker than the present thickness.

With such a configuration, it is possible to prevent the temperature of the outer ring 16B from dropping and thereby to achieve effects that are similar to those of the rotary machine 10 according to the first embodiment described above.

Also, the configuration in which at least either the thickness of the bearing housings 13 and 15 or the thickness of the casing 18 is thicker than the present thickness may be applied to the rotary machines 10, 40, 50, 60, and 70 according to the first to fifth embodiments.

Hereinafter, a comparative example and an example will be described. The invention is not limited to the following examples.

### Comparative Example

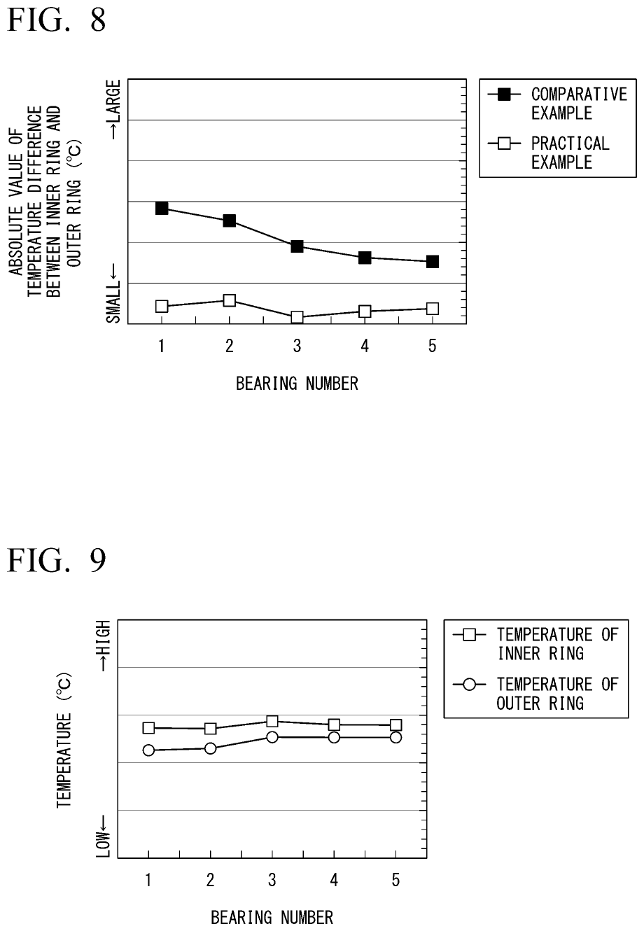

In a comparative example, a rotary machine with a configuration in which the heat insulation material 42 was removed from the rotary machine 40 illustrated in FIG. 2 (hereinafter, referred to as a “rotary machine in a comparative example”) was prepared in a comparative example. In a state in which the lubricant oil is sprayed on the plurality of bearings 16, temperatures of the inner ring 16A and the outer ring 16B that were included in each of the bearings 16 (the five bearings disposed in the axial line O direction) were measured, and an absolute value of the temperature difference between the inner ring 16A and the outer ring 16B included in each of the bearings 16 was obtained. The result is illustrated in FIG. 8.

In FIG. 8, numbers (1 to 5) indicating the positions of the five bearings 16 are represented by the horizontal axis, and the absolute value (° C.) of the temperature difference between the inner ring 16A and the outer ring 16B is represented by the vertical axis.

“1” represents the bearing 16 disposed at the base end of the rotating element 11 (an end of the base end 11B), and “2” represents the bearing 16 disposed so as to be adjacent to “1” from among the five bearings 16 in FIG. 8. “5” represents the bearing 16 disposed at the tip end of the rotating element 11 from among the five bearings 16 in FIG. 8.

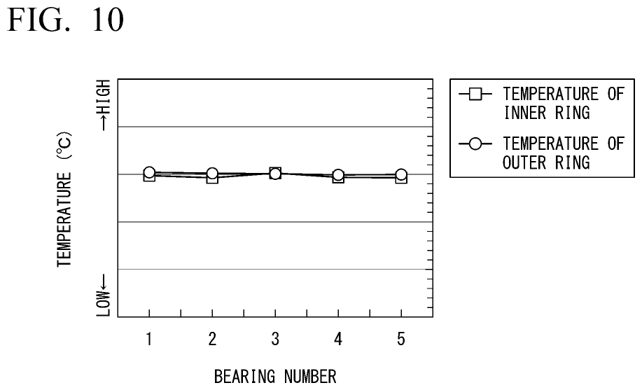

FIG. 9 illustrates the temperatures of the inner rings 16A and the temperatures of the outer rings 16B of the five bearings 16 (“1 to 5” illustrated in FIG. 9 are numbers of the bearings 16 corresponding to “1 to 5” in FIG. 8) included in the rotary machine in the comparative example.

### Practical Example

In a practical example, the rotary machine 40 illustrated in FIG. 2 was used. In the practical example, a heat insulation material made of rock wool manufactured by Nichias Corporation was used as the heat insulation material 42. The thickness of the heat insulation material 42 was set to 1 cm.

In a state in which a lubricant oil was sprayed on the plurality of bearings 16, temperatures of the inner ring 16A and the outer ring 16B that were included in each of the bearings 16 (the five bearings disposed in the axial line O direction) were measured, and an absolute value of the temperature difference between the inner ring 16A and the outer ring 16B that were included in each of the bearings 16 was obtained. The result is illustrated in FIG. 8.

FIG. 10 illustrates temperatures of the inner rings 16A and temperatures of the outer rings 16B of the five bearings (1 to 5) that are included in the rotary machine in the practical example.

### Conclusion Regarding Results of Comparative and Practical Examples

With reference to FIGS. 8 to 10, it was possible to confirm that the temperature difference between the inner ring 16A and the outer ring 16B in the practical example became smaller than the temperature difference between the inner ring 16A and the outer ring 16B in the comparative example.

On the basis of this, it was possible to confirm that the lifetime of the bearings 16 could be easily prevented from being shortened using the rotary machine 40 in the practical example.

Also, it was confirmed that it is possible to prevent the temperatures of the inner ring and the outer ring from rising due to influences of the lubricant oil even in a case in which the heat insulation material 42 was used from the results illustrated in FIGS. 9 and 10.

### INDUSTRIAL APPLICABILITY

The invention can be applied to a rotary machine.

### REFERENCE SIGNS LIST

10, 40, 50, 60, 70 Rotary machine

11 Rotating element

11a, 13a, 15a, 27a, 31a Outer peripheral surface

11A Tip end

11B Base end

11C Bearing support portion

13, 15 Bearing housing

16 Bearing

16A Inner ring

16B Outer ring

16C Rolling element

18 Casing

18a, 18b Inner peripheral surface

18c, 21a Outer surface

19, 41, 51, 61, 71, 72 Temperature difference reducer

21 Support member

21A Through-hole

22 Sealing member

27, 31 Bearing housing main body

27b, 31b Outer ring fixed surface

28, 32 Lubricant oil-spraying portion

35, 36 Recessed portion

42 Heat insulation material

52, 53 Low-heat conductivity member

62, 63 Heat-generating element

A, B Region

O Axial line

1-6. (canceled)

7. A rotary machine, comprising:
a rotating element;
a bearing including an inner ring secured to an outer peripheral surface of the rotating element, an outer ring disposed outside the inner ring, and a plurality of rolling elements interposed between the inner ring and the outer ring;
a bearing housing, which is disposed outside the bearing, to which the outer ring is secured;
a casing, which is disposed outside the bearing housing, to which the bearing housing is secured; and
a temperature difference reducer configured to reduce a difference between a temperature of the outer ring and a temperature of the inner ring,
wherein the temperature difference reducer includes a recessed portion formed on a portion of the casing which is brought into contact with an outer peripheral surface of the bearing housing, and
the recessed portion is a hole.

8. The rotary machine according to claim 7,
wherein the temperature difference reducer includes a heat insulation material installed on an outer surface of the casing, and
the bearing housing has a lubricant oil-spraying portion configured to spray a lubricant oil on the bearing.

9. The rotary machine according to claim 7, wherein the temperature difference reducer includes a low-heat conductivity member that is disposed between the bearing housing and the casing and has a lower heat conductivity than that of the casing.

10. The rotary machine according to claim 7,
wherein the temperature difference reducer includes a heat-generating element installed between the bearing housing and the casing and to heat the bearing housing, and
the bearing housing has a lubricant oil-spraying portion configured to spray a lubricant oil on the bearing.

11. The rotary machine according to claim 7,
wherein at least one of the outer peripheral surface of the bearing housing and an inner peripheral surface of the casing which is brought into contact with the outer peripheral surface of the bearing housing is a rough surface, and
the temperature difference reducer includes the rough surface.

12. The rotary machine according to claim 8, wherein the temperature difference reducer includes a low-heat conductivity member that is disposed between the bearing housing and the casing and has a lower heat conductivity than that of the casing.

13. The rotary machine according to claim 8,
wherein the temperature difference reducer includes a heat-generating element installed between the bearing housing and the casing and to heat the bearing housing, and
the bearing housing has a lubricant oil-spraying portion configured to spray a lubricant oil on the bearing.

14. The rotary machine according to claim 8,
wherein at least one of the outer peripheral surface of the bearing housing and an inner peripheral surface of the casing which is brought into contact with the outer peripheral surface of the bearing housing is a rough surface, and
the temperature difference reducer includes the rough surface.

15. The rotary machine according to claim 9,
wherein at least one of the outer peripheral surface of the bearing housing and an inner peripheral surface of the casing which is brought into contact with the outer peripheral surface of the bearing housing is a rough surface, and
the temperature difference reducer includes the rough surface.

16. The rotary machine according to claim 10,
wherein at least one of the outer peripheral surface of the bearing housing and an inner peripheral surface of the casing which is brought into contact with the outer peripheral surface of the bearing housing is a rough surface, and
the temperature difference reducer includes the rough surface.
